(19) United States
(12) Patent Application Publication
(10) Pub. No.: US 2006/0027177 A1
(43) Pub. Date: Feb. 9, 2006

(54) Pet butler

(76) Inventor: Nancy Jean Busse, Clay Center, KS (US)

Correspondence Address: Nancy J. Busse, Apt #:11105, 7990 East Snyder Road, Tucson, AZ, 85750, US

(21) Appl. No.: 10/911,136

(22) Filed: Aug. 4, 2004

(51) Int. Cl. A01K 5/01

(52) U.S. Cl. 119/61.56

(57) ABSTRACT

My invention, the Pet Butler, is to be used by pet owners so they can provide their pets a sanitary and hygienic food station. In addition, it provides an orderly and hygienic area in the home where the pet can be fed without causing a mess on floors or surrounding areas. It is simple to construct the enclosure that can be erected in minutes without use of significant physical exertion or tools.

### BACKGROUND OF THE INVENTION

The field of endeavor of this invention is primarily pet care, although it goes well beyond that. The care of household pets is enhanced through use of this invention because it allows constant access to food and water in an open, yet sanitary, location. It also lends itself to creation of an orderly and clean area for feeding household pets by restricting their food and water to an area that is protected by the Pet Butler. It is a valuable device to use for optimum care of household pets and to attain an orderly and hygienic household environment.

### BRIEF SUMMARY OF THE INVENTION

Household pet feeding bowls/containers are placed on the floor in a room chosen by the owner. In their haste to feed themselves, pets invariably push food from the bowls out onto the floor of the room in which they are being fed. The same applies for their water bowls. This creates a mess that has to be repeatedly attended to by the pet owner. Through use of the Pet Butler, this irritant is virtually eliminated, as all spills will conveniently be retained within the Pet Butler structure.

### BRIEF DESCRIPTION OF THE SEVERAL VIEWS OF THE DRAWING

FIG. 1/2 depicts the trademark logo to be used for this invention. It is simply a butler presenting the Pet Butler (on top of tray) to interested parties. In FIG. 2/2, it gives more detailed information concerning the Pet Butler. It reveals that the Pet Butler will be available in various sizes (large, medium or small) to coincide with the size of household pets. It also shows that the Pet Butler can be obtained made from various materials. Then it indicates the various coverings that will be available to consumers.

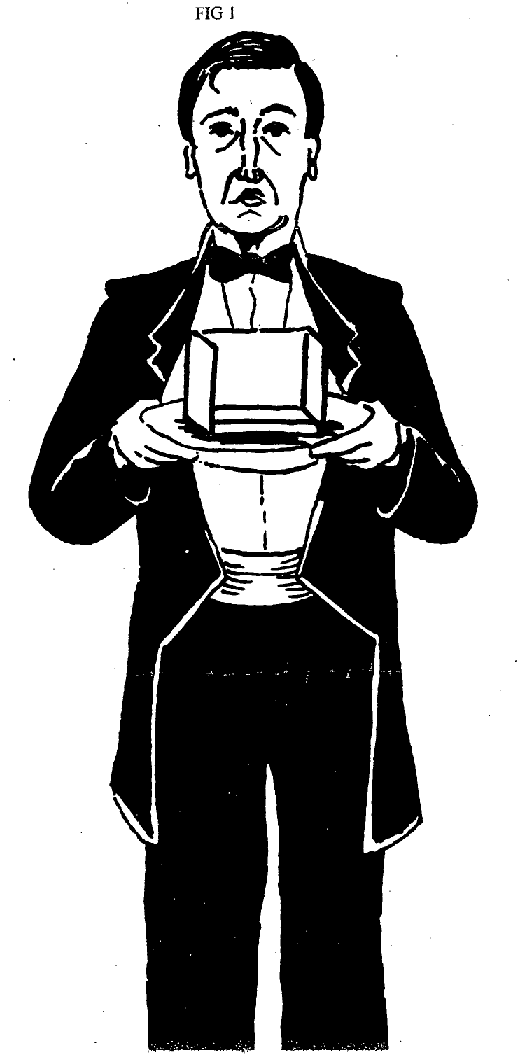

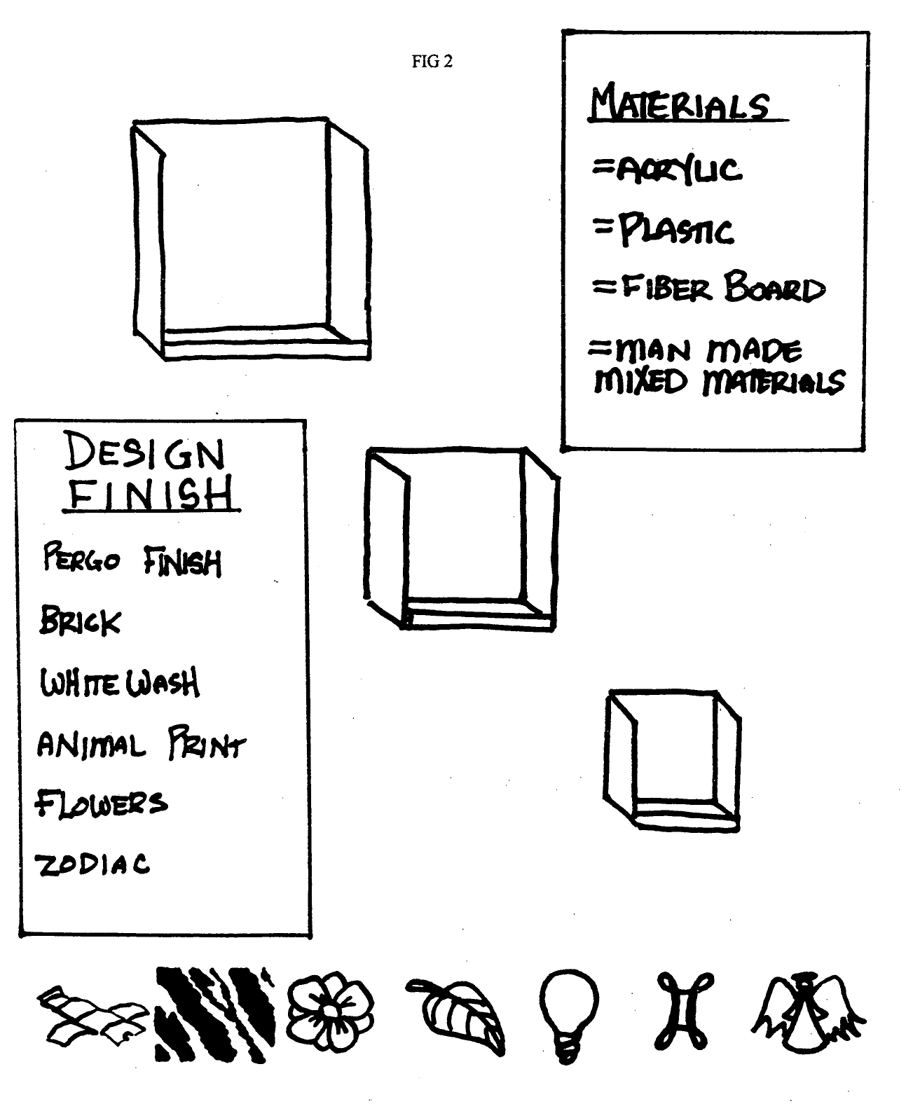

### DETAILED DESCRIPTION OF THE INVENTION

The Pet Butler was designed to eliminate the mess that is invariably made when pets reside indoors and are fed indoors. Pets drop food particles on the floor and spill water from their dishes. When food and water dishes are placed inside the Pet Butler, food and water debris will be retained inside the food station, thus creating a vastly improved hygienic and orderly environment. To use this invention you simply put together an easily erected box that is slotted for simple insertion to create a perfect Pet Butler. Once erected, you then simply place the pet's food and water bowls on the floor of the feeding station. The pet will go to where their food and water is presented. When using the Pet Butler their dribbles and food droppings will remain inside the food station, thus eliminating debris or any mess on household floors. The only clean up that may be required will be isolated within the Pet Butler which will significantly upgrade household sanitary conditions. Sizes of the Pet Butler will be large, medium and small to accommodate large, medium and small pets. The Pet Butler may be decorated with an assortment of different figures to fit the taste of the consumer. Various materials may also be selected to accommodate the specific pet for which it is being purchased, i.e., more sturdy for larger pets, less sturdy for small, docile pets. An individuals' goal of eliminating messes made by pets while eating will be controlled through use of the Pet Butler.

1. What I claim as my invention is the Pet Butler.

2. The Pet Butler is a feeding station for household pets.

3. It will be prefabricated so that it can be easily and quickly assembled.

4. Anyone will be able to put it together, place pet bowls inside and locate it in a desired area of the house, fill the bowls and forget it.

5. The pet(s) may then go to the Pet Butler when thirsty or hungry and use the station without making any mess on the floors.

6. It is a sanitary and hygienic way to take care of pets and significantly reduce workload for the owner by eliminating cleanup.
